(19) United States
(12) Patent Application Publication
(10) Pub. No.: US 2021/0136455 A1
(43) Pub. Date: May 6, 2021

(54) COMMUNICATION APPARATUS, COMMUNICATION CONTROL METHOD, AND COMPUTER PROGRAM

(71) Applicant: CANON KABUSHIKI KAISHA, Tokyo (JP)

(72) Inventor: Yuki Fujimori, Kawasaki-shi (JP)

(21) Appl. No.: 17/148,396

(22) Filed: Jan. 13, 2021

Related U.S. Application Data
(63) Continuation of application No. 16/074,693, filed on Aug. 1, 2018.

(30) Foreign Application Priority Data
Feb. 3, 2016 (JP) 2016-019295

(51) Int. Cl. H04N 21/4728; H04N 21/2343; H04N 21/845; H04N 21/4402; H04N 21/854; H04N 21/262; H04N 21/858

(52) U.S. Cl. CPC H04N 21/4728; H04N 21/234345; H04N 21/8456; H04N 21/8586; H04N 21/85406; H04N 21/26258; H04N 21/440245

(57) ABSTRACT

A communication apparatus includes an identifying unit configured to identify an object region having an object within a video image, a generating unit configured to generate a meta data segment including an identifier or identifiers of one or more objects corresponding to one or more object regions identified by the identifying unit, a transmitting unit configured to transmit the meta data segment generated by the generating unit to another communication apparatus, and a supplying unit configured to supply a video segment of an object region corresponding to an object selected in the other communication apparatus receiving the meta data segment to the other communication apparatus.

### CROSS-REFERENCE TO RELATED APPLICATIONS

This application is continuation of U.S. patent application Ser. No. 16/074,693, filed on Aug. 1, 2018, which is a national phase application of international application PCT/JP2017/002656, filed on Jan. 26, 2017, and claims the benefit of, and priority to, Japanese Patent Application No. 2016-019295, filed Feb. 3, 2016, which applications are hereby incorporated by reference herein in their entireties.

### TECHNICAL FIELD

The present invention relates to a communication apparatus, a communication control method, and a computer program, and it particularly relates to a video data streaming technology.

### BACKGROUND ART

In recent years, distribution systems have been provided which stream a content such as audio data and video data. Such a distribution system provides a user with real time enjoyment of a requested content such as live video through a terminal apparatus carried by the user. With wide spread of terminals such as smartphones and tablet type PCs, there has been an increasing demand for using various terminal apparatuses to enjoy streaming contents anywhere and anytime. In order to meet such a demand, a technology (such as MPEG-DASH and Http Live Streaming) for dynamically changing a stream to be acquired in accordance with the capability or communication state of a terminal apparatus of a user has gathered attention. “ISO-IEC 23009-1” provides a “Dynamic Adaptive Streaming over HTTP (DASH)” technology. “draft-pantos-http-live-streaming-16” provides a “Http Live Streaming” technology.

According to these technologies, video data are divided into detail segments in time units, and a URL (Uniform Resource Locator) for acquiring one of the segments is described in a file called a playlist. A receiving apparatus is configured to acquire such a playlist and acquire desired video data by using information described in the playlist.

Here, URLs for a plurality of versions of a video data segment are described in a playlist. Thus, a receiving apparatus can select an optimum version of video data from the playlist and acquire the selected video data segment in accordance with the capability of the receiving apparatus and the communication environment.

PTL 1 discloses a technology for distributing video data regarding a region focused by a user in video data by applying a technology relating to a playlist describing a URL from which a receiving apparatus can acquire the corresponding video data segment. The focused region in video data is called a Region Of Interest (hereinafter “ROI”). More specifically, according to PTL 1, video data can be divided in advance into tile-shaped regions, and data of the whole video and data of an ROI showing an object focused by a user in the data of the whole video can be distributed.

Because the number and position of an object shown in video data to be distributed may change in time-series manner, it is difficult to designate in advance a region including a target object as an ROI before the video data is distributed.

### CITATION LIST

### Patent Literature

### [PTL 1]

British Patent GB2505912B

### SUMMARY OF INVENTION

An aspect of the present invention provides a communication apparatus including an identifying unit configured to identify an object region having an object within a video image, a generating unit configured to generate a meta data segment including an identifier or identifiers of one or more objects corresponding to one or more object regions identified by the identifying unit, a transmitting unit configured to transmit the meta data segment generated by the generating unit to another communication apparatus, and a supplying unit configured to supply a video segment of an object region corresponding to an object selected in the other communication apparatus receiving the meta data segment to the other communication apparatus.

Further features of the present invention will become apparent from the following description of exemplary embodiments with reference to the attached drawings.

### BRIEF DESCRIPTION OF DRAWINGS

FIG. 1 is a configuration diagram illustrating an image distribution system according to an embodiment.

FIG. 2 is a block diagram illustrating a functional configuration of a transmitting apparatus according to an embodiment.

FIG. 3 is a block diagram illustrating a functional configuration of a receiving apparatus according to an embodiment.

FIG. 4A illustrates a concrete example of a video image to be displayed according to an embodiment.

FIG. 4B illustrates concrete examples of video images to be displayed according to an embodiment.

FIG. 5 illustrates a concrete example of a playlist according to an embodiment.

FIG. 6 illustrates a concrete example of a playlist according to an embodiment.

FIG. 7 illustrates a concrete example of meta data according to an embodiment.

FIG. 8 illustrates a concrete example of meta data according to an embodiment.

FIG. 9 illustrates a concrete example of a playlist according to an embodiment.

FIG. 10 illustrates a concrete example of processing to be performed by a transmitting apparatus according to an embodiment.

FIG. 11 illustrates a concrete example of processing to be performed by a receiving apparatus according to an embodiment.

FIG. 12 illustrates a concrete example of processing to be performed by a receiving apparatus according to an embodiment.

FIG. 13A illustrates a specific display example of a user interface unit.

FIG. 13B illustrates a specific display example of a user interface unit.

FIG. 14 is a sequence diagram illustrating communication between a transmitting apparatus and a receiving apparatus.

FIG. 15 is a sequence diagram illustrating communication between a transmitting apparatus and a receiving apparatus.

FIG. 16 illustrates an example of a hardware configuration of units according to an embodiment.

### DESCRIPTION OF EMBODIMENTS

Embodiments of the present invention will be described in detail below with reference to attached drawings. The embodiments which will be described below are examples for embodying the present invention and should be modified or changed in accordance with the configuration of an apparatus to which the present invention is applied and in accordance with the conditions under which the present invention is applied. It is not intended that the present invention is limited to the following embodiments.

In a communication system according to an embodiment, a video data transmitting apparatus notifies a receiving apparatus through a playlist of information by which an object to be a candidate of a focused region (ROI) in video data can be identified (such as position information such as coordinate information and size information). The receiving apparatus prompts a user to select a target ROI from ROI candidates, transmits information by which an object in the selected ROI can be identified to a transmitting apparatus, and causes the transmitting apparatus to distribute a video segment including the selected ROI. The information by which an object can be identified may be information by which an object can be identified absolutely based on a name or an ID of the object, for example, or may be information by which an object can be identified relatively, such as a third item on a list. The coordinate information if used may be information regarding absolute coordinates of an object by which the object can be identified or may be information regarding a relative position of an object on a screen or a video image.

### Overall Configuration of System of Embodiment

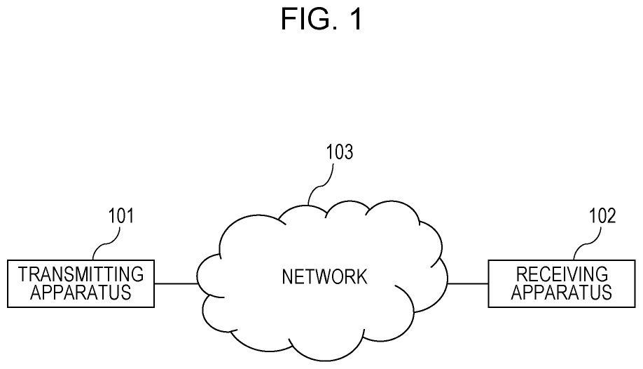

FIG. 1 illustrates an overall configuration of a communication system which distributes video data according to an embodiment. A transmitting apparatus 101 (communication apparatus) according to this embodiment is connected to the receiving apparatus 102 (communication apparatus) over a network 103. While FIG. 1 only illustrates one transmitting apparatus 101 and one receiving apparatus 102, the communication system may include a plurality of transmitting apparatuses 101 and a plurality of receiving apparatuses 102.

The transmitting apparatus 101 is a transmitting apparatus configured to distribute video data according to this embodiment. The transmitting apparatus 101 may specifically be a camera apparatus, a video camera apparatus, a smartphone apparatus, a PC apparatus, or cellular phone, for example, which satisfies requirements for its functional configuration, which will be described below, and may not be limited to the following example apparatuses.

The receiving apparatus 102 is a receiving apparatus configured to receive video data according to this embodiment. The receiving apparatus 102 may specifically be a smartphone apparatus, a PC apparatus, a television, or a cellular phone, for example, which satisfies requirements for its functional configuration, which will be described below, and may not be limited to the following example apparatuses.

The network 103 is a network usable for distributing video data according to this embodiment and may be any network which is capable of transmitting video data. For example, a wired LAN (Local Area Network) or a wireless LAN (Wireless LAN) may be usable. The network 103 may be, without limiting thereto, an LTE (Long Term Evolution) or 3G WAN (Wide Area Network), for example. Alternatively, the network 103 may be a PAN (Personal region Network) such as Bluetooth (registered trademark) or Zigbee (registered trademark).

### [Functional Configuration of Transmitting Apparatus 101]

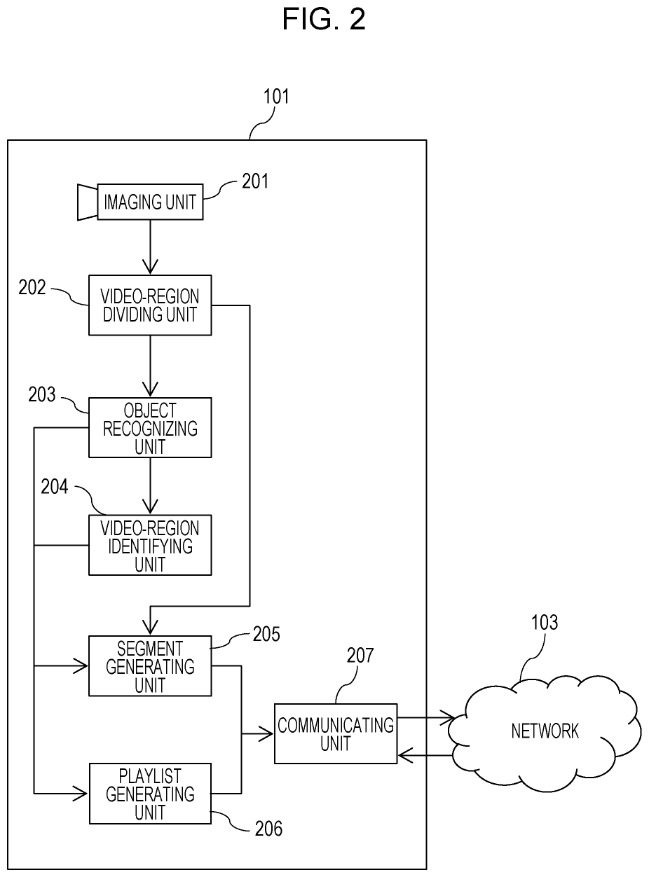

FIG. 2 illustrates a functional configuration of the transmitting apparatus 101 according to this embodiment. The transmitting apparatus 101 according to this embodiment includes an imaging unit 201, a video-region dividing unit 202, an object recognizing unit 203, a video-region identifying unit 204, a segment generating unit 205, a playlist generating unit 206, and a communicating unit 207.

The imaging unit 201 is configured to capture an image and output video data. The video-region dividing unit 202 is configured to region-divide video data captured by the imaging unit 201 and encode them. As a result, the video-region dividing unit 202 outputs the region-divided and encoded video data. The video-region dividing unit 202 has a function of encoding whole video data before the region division. While FIG. 2 illustrates that the imaging unit 201 is provided within the transmitting apparatus 101, the imaging unit 201 may be provided externally to the transmitting apparatus 101 and may provide video data to the transmitting apparatus 101. An example will be described in which data are encoded by HEVC (High Efficiency Video Coding). However, an embodiment of the present invention is not limited thereto. For example, any encoding method such as H.264, MPEG2 (Moving Picture Experts Group phase 2) or the like may be used instead.

In video data encoded by the video-region dividing unit 202, the object recognizing unit 203 recognizes a possible object for an ROI candidate shown in the video data. The object recognition method to be executed by the object recognizing unit 203 is a method by which a plurality of objects shown in video data can be recognized simultaneously and which outputs, as a recognition result, position information (coordinate information and size) of each of the objects in the video data. The object recognizing unit 203 may be provided externally to the transmitting apparatus 101. The object recognizing unit 203 provided externally may receive encoded video data from the transmitting apparatus 101 and may transmit position information (coordinate information and size) as a result of recognition of objects in video data to the transmitting apparatus 101.

The video-region identifying unit 204 may use the position information (coordinate information and size) as a result of recognition of objects recognized by the object recognizing unit 203 to identify a video region including an object (hereinafter, called “object region”) from video regions as a result of the division performed by the video-region dividing unit 202.

The segment generating unit 205 is configured to generate a video segment and a meta data segment. The video segment is data including a video region (object region) identified by the video-region identifying unit 204 and entire video data. The segment generating unit 205 may generate a video segment including an object region as a video segment.

On the other hand, the meta data segment is data including attribute information on a playlist and coordinate information in video of an object. The attribute information on a playlist may include, for example, information regarding the number of objects and a band of video data. The meta data segment may be called a coordinate segment because it includes coordinate information.

The meta data segment may include position information regarding an object. The position information may include coordinate information regarding an object in video data and a size of the object, as described above. Any information may be applied if it relates to the position of an object and may include information regarding a contour line of an object, coordinate information regarding vertices of an object, or information regarding an orientation of an object, for example. Coordinate information in a meta data segment may be absolute coordinates or relative coordinates, as described above.

A video segment according to this embodiment may have a file format such as ISOBMFF (Base Media File Format). However, without limited thereto, the file format may be a format such as MPEG2TS (MPEG2 Transport Stream).

The playlist generating unit 206 (third generating unit) generates a playlist describing a URL (which will be called a “resource identifier” or “access identifier”) which enables to access a video segment or a meta data segment generated by the segment generating unit 205. According to this embodiment, a URL (resource identifier) is used as an identifier for accessing a video segment. However, other identifiers or link information may be used for accessing a video segment.

The communicating unit 207 is configured to transmit the generated playlist and segment (video segment and meta data segment) to the receiving apparatus 102 through the network 103 in response to a request from the receiving apparatus 102.

The identifier may be MPD (Media Presentation Description) defined in MPEG-DASH as a playlist format. According to this embodiment, MPD is used as an example. However, any format such as a playlist description method in “http Live streaming” may be used if it has functionality equivalent to MPD.

### [Functional Configuration of Receiving Apparatus]

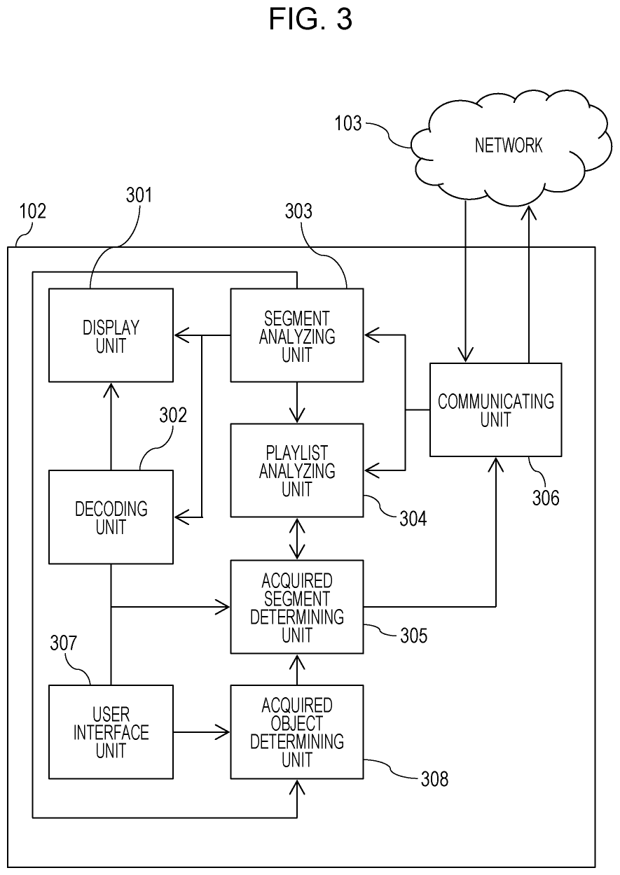

FIG. 3 is a functional configuration of the receiving apparatus 102 according to this embodiment.

The receiving apparatus 102 according to this embodiment includes a display unit 301, a decoding unit 302, a segment analyzing unit 303, a playlist analyzing unit 304, an acquired segment determining unit 305, and a communicating unit 306. The receiving apparatus 102 further includes a user interface unit 307 and an acquired object determining unit 308.

The display unit 301 is configured to display a video segment decoded by the decoding unit 302 and display meta data analyzed by the segment analyzing unit 303 based on a meta data segment. The display unit 301 may display an ROI within a video segment as required. The decoding unit 302 is configured to decode a video bit stream output from the segment analyzing unit 303 and supplies to and causes the display unit 301 to display the decoded video segment.

The segment analyzing unit 303 is configured to analyze a video segment and a meta data segment output from the communicating unit 306. The segment analyzing unit 303 outputs a video bit stream acquired by analyzing a video segment to the decoding unit 302. The segment analyzing unit 303 analyzes a meta data segment to acquire coordinate information regarding an object and attribute information on a playlist. The acquire coordinate information regarding an object is output to the display unit 301 and the acquired object determining unit 308. On the other hand, the acquired attribute information on the playlist is output to the playlist analyzing unit 304.

The playlist analyzing unit 304 is configured to analyze a playlist output from the communicating unit 306. The playlist analyzing unit 304 is further configured to partially update a playlist by using attribute information on a playlist acquired from a meta data segment output from the segment analyzing unit 303.

The acquired object determining unit 308 is configured to determine an object whose video is to be acquired as an ROI focused by a user based on a user input notified from the user interface unit 307 and coordinate information regarding the object output from the segment analyzing unit 303.

The acquired segment determining unit 305 determines a video segment to be acquired which includes an object in an ROI and acquisition timing for it based on the object determined by the acquired object determining unit 308 and a user input output from the user interface unit 307. The information and acquisition timing regarding the determined segment to be acquired are output to the communicating unit 306.

The communicating unit 306 is configured to request a playlist and segment (video segment and meta data segment) to the transmitting apparatus 101 through the network 103 and receive the playlist and the segment (video segment and meta data segment). The playlist may be data including a URL being an access identifier for a video segment, as described above. Alternatively, the playlist may be data including a URL being an access identifier for a meta data segment (coordinate segment).

The user interface unit 307 is configured to receive a user input and notifies the acquired object determining unit 308 of the selected object as an ROI. According to this embodiment, the user interface unit 307 may be a touch panel. However, without limiting thereto, the user interface unit 307 may be a mouse, a keyboard, audio input or other kinds of input. [Concrete Examples of video image to be Displayed]

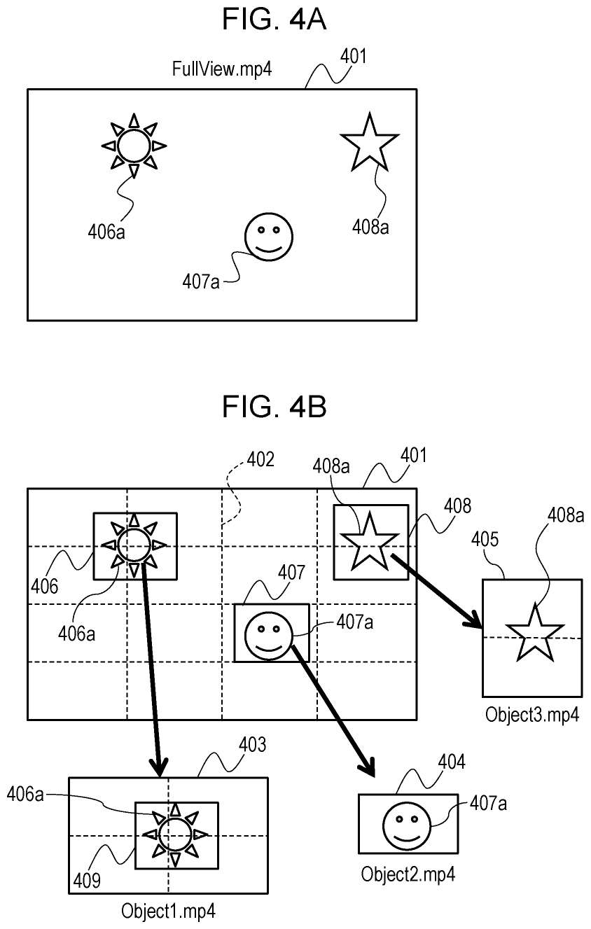

FIGS. 4A and 4B illustrate concrete examples of video images to be displayed according to this embodiment. FIG. 4A illustrates whole a video image 401 before a region division is performed thereon. FIG. 4B illustrates how the whole video image 401 undergoes a region division.

FIG. 4B illustrates broken lines each indicating a boundary between divided regions in the video image 402 after the division. According to this embodiment, it is assumed that objects 406a, 407a, and 408a are recognized which are present in three areas defined by frames 406, 407, and 408, respectively, in the whole video image 401. It should be noted that the number of objects is not limited to three but may be equal to or higher than zero.

In a case where the region including the objects are estimated as ROIs and where video data of the ROIs are to be only displayed by the receiving apparatus 102, the divided regions 403, 404, and 405 including the ROI objects may only be acquired from the transmitting apparatus 101.

In a case where the ROI for the object 406a is to be displayed in the receiving apparatus 102, a video segment corresponding to the divided region 403 may be acquired and be directly displayed. Alternatively, an object part 409 in the ROI may be extracted from the divided region 403 and may be displayed.

### Concrete Example of Playlist

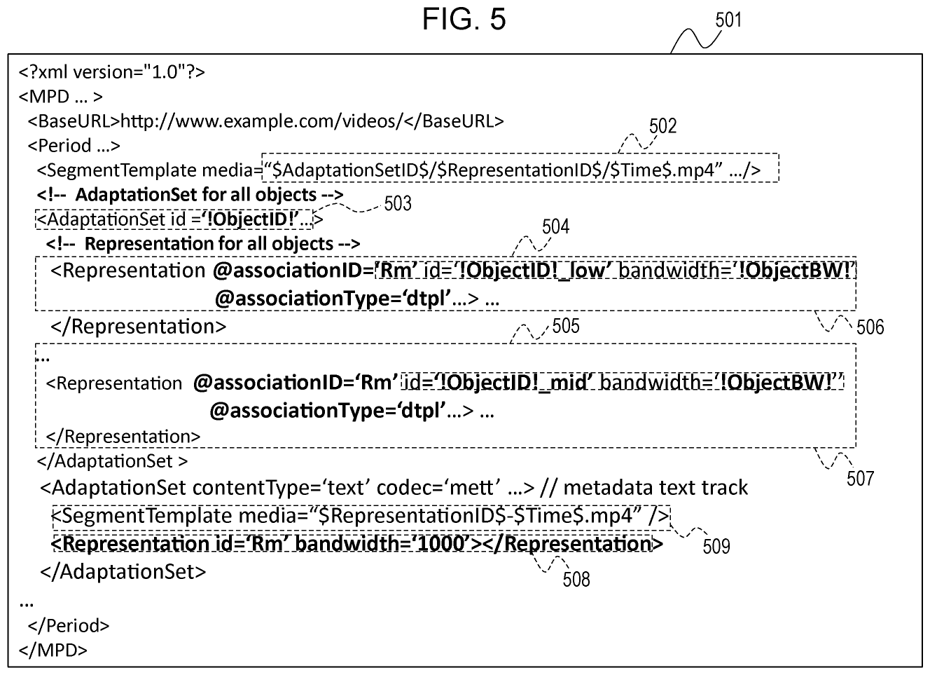

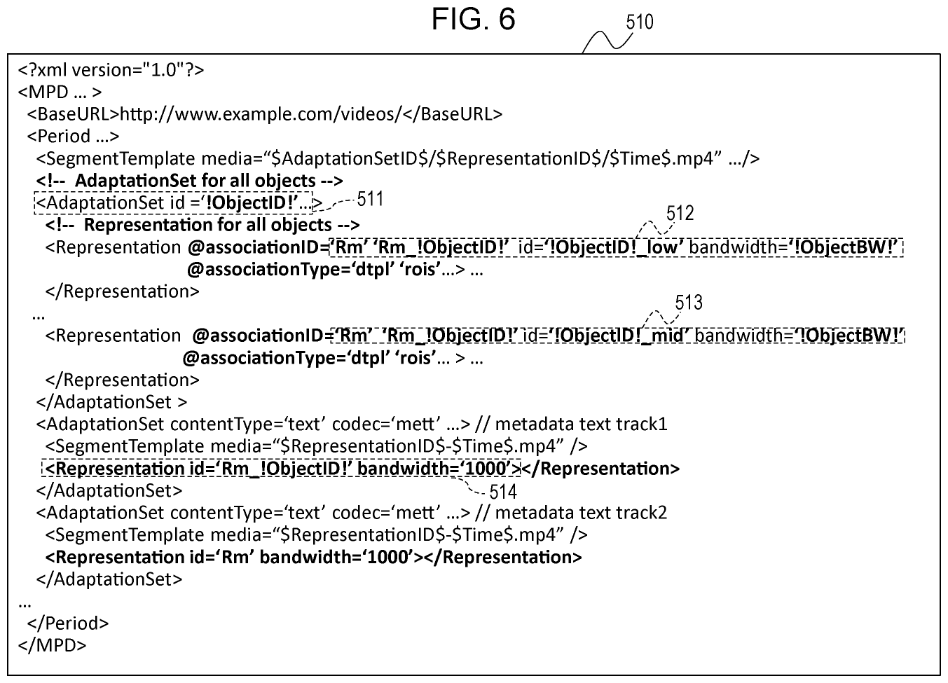

With reference to FIGS. 5 and 6, concrete examples of a playlist according to this embodiment will be described. FIGS. 5 and 6 illustrate playlists 501 and 510, respectively, which are actual description examples based on an MPD format defined in MPEG-DASH. According to this embodiment, an MPD format is applied, for example. However, embodiments of the present invention are not limited thereto, but an equivalent playlist defined in HLS (HTTP Live Streaming) or other playlists may be applied. Each of the playlists 501 and 510 is a playlist example which enables distribution of streams at two types of bit rate to a plurality of objects. It should be noted that though the number of types of bit rate is two in this embodiment, an embodiment of the present invention is not limited thereto. Three or more types of bit rate may be applied. A method is provided which uses a symbol “$” as in a template 502 to template a character string within a playlist in the MPD format in FIG. 5.

This embodiment proposes a dynamic template which is an extension of the method. The dynamic template is a mechanism which replaces partial attribute information within the playlist 501 or 510 by a value included in an associated meta data stream so that attribute information (video segment information) in the playlist can be dynamically updated.

Thus, a video segment in the playlist and a meta data segment (coordinate segment) can be associated.

According to this embodiment, FIG. 5 illustrates dynamic templates 503 to 505, and FIG. 6 illustrates dynamic templates 511 to 514.

According to this embodiment, symbols “!” are put around a part by which a value can be replaced in a dynamic template. However, an embodiment of the present invention is not limited to the symbol, and other symbols may be used. A dynamic template (such as 503 to 505) may be dynamically replaced by a value defined within a meta data stream. For example, “!ObjectID!” in the dynamic template 503 can be updated by using information within a Representation 508 which represents an associated meta data stream. The playlist generating unit 206 (third generating unit) according to this embodiment generates the playlist having contents that can be updated on the basis of information of the meta data segment.

A representation (such as 508) for updating a dynamic template (such as 503 to 505) may be identified in the following manner. For example, a representation is identified by AssociationID (hereinafter “AID”) and AssoiciationType (hereinafter “AType”) in the playlist 501. AID=‘Rm’ and AType=‘dtpl’ are described as representation attributes of representations 506 and 507. This can express a relationship as a dynamic template to a meta data stream (having an ID ‘Rm’) in the representation 508. The Atype information is information regarding a relationship between a video segment and a meta data segment (coordinate segment). This can associate the meta data stream (meta data segment set) with the video segment.

According to this embodiment, dtpl′ is given as AType indicating a dynamic template. However, an embodiment of the present invention is not limited thereto, but other character strings may be used as AType indicating a dynamic template.

Next, a specific method for using a dynamic template will be described with reference to the playlist 501. In the playlist 501, “!ObjectID!” having symbols “!” therearound and an “!ObjectBW!” attribute are updated with a representation indicated by a representation ID ‘Rm’ (hereinafter, “representation Rm”). For example, the representation Rm at a time t can be acquired by requesting it to a URL of <BaseURL>/Rm-t.mp 4 on the basis of information regarding the template 509 and information regarding BaseURL.

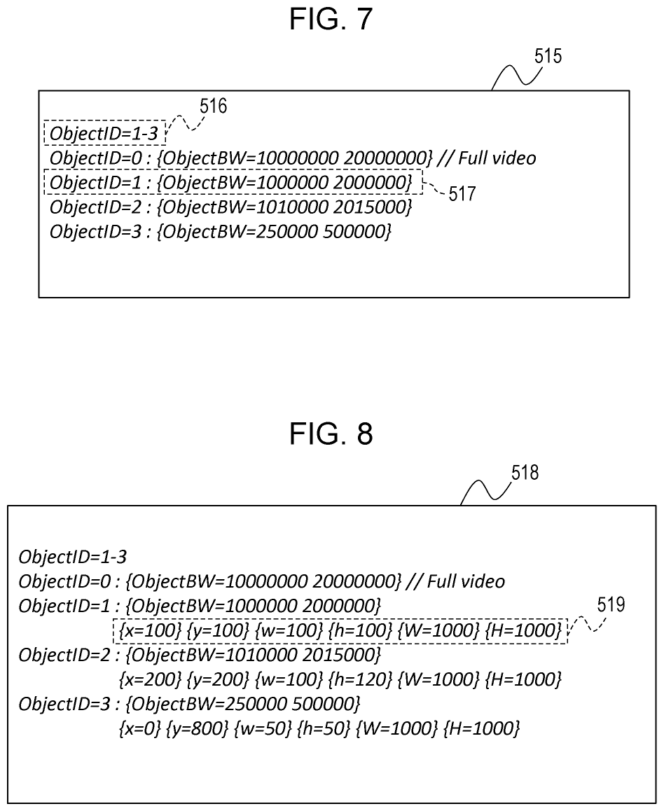

FIGS. 7 and 8 illustrate meta data examples within a stream acquired in response to the request. According to this embodiment, FIGS. 7 and 8 illustrate meta data description examples. However, an embodiment of the present invention is not limited thereto, but other formats such as XML (Extensible Markup Language) and binary XML may be used for the description. Meta data may be described in a data description language such as JSON (JavaScript (registered trademark) Object Notation).

First, meta data 515 in FIG. 7 will be described. The description on a row 516 in the meta data 515 describes that there are three ObjectIDs of ObjectID=1, ObjectID=2, and ObjectID=3. This means that the three objects in a video at the time t are recognized and are defined as ROI candidates. According to this embodiment, ObjectID=0 represents a whole video image before divided. Thus, the whole video image can be distributed without requiring to add a description to the meta data 515. Alternatively, a stream showing a whole video image may be described separately within the playlist 501 as another Adaptationset without using a dynamic template.

For example, a row 517 describes that there are two types of bandwidth of streams having an object indicated by ObjectID=1 as an ROI, from which it is understood that the row 517 has two types of value. These values (bandwidths) can be used to update “!ObjectID!” in the dynamic templates 503 to 505 and “!ObjectBW!” in the dynamic templates 504 and 505 in the playlist to the values at the time t. For example, the video stream in the ROI corresponding to ObjectID=1 at the time t can be acquired by requesting it to a URL of <BaseURL>/1/1_low (or mid)/t.mp 4. The bandwidths at that time are 1000000 for 1_low and 2000000 for 1_mid. Though information at the specific time t is only described according to this embodiment, information at a plurality of times may be described within one meta data segment. In this case, for example, “$Number$” may be used instead of “$Time$” as a parameter to be used in the templates 502 and 509.

By using the meta data segment 515 in the manner as described above, the number of objects at the time t and the bandwidths of the streams having the objects as ROIs can be updated. Thus, video streams of the ROIs can be acquired without updating the playlist itself.

However, only from the meta data 515 in FIG. 7, which ObjectID corresponds to which object within a screen. Accordingly, in this embodiment, coordinate information within a screen of an object is added as meta data as in meta data 518 illustrated in FIG. 8. Referring to FIG. 8, the coordinate information is described by using w as a width and h as a height of an object as in the row 519 where an upper left end within a screen is the origin, x is a horizontal position of an object at a time t, y is a vertical position, W is a width of the entire screen, and H is a height. Thus, an ObjectID of each object can be associated with the object within a screen in the receiving apparatus 102.

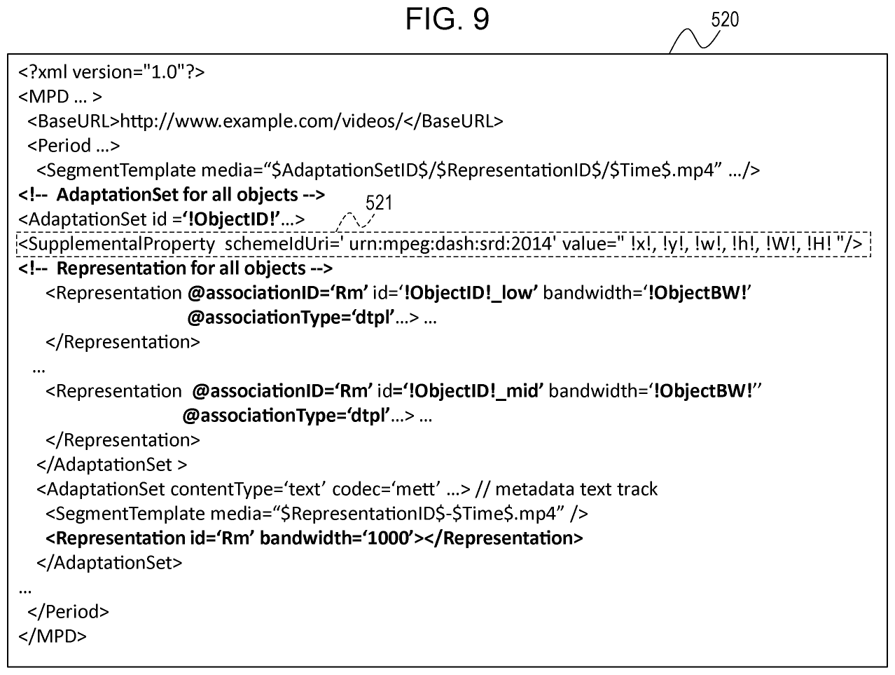

This value may be used to handle attribute values defined in a “urn:mpeg:dash:srd:2014” scheme indicated in the dynamic template 521 in the playlist 520 in FIG. 9 as a dynamic template, and the dynamic template may be updated with a meta data stream.

It should be noted that all meta data may not be necessary distributed in one meta data stream as illustrated in FIG. 6 but may be divided into a plurality of meta data tracks for distribution. In the playlist 510 in FIG. 6, a first meta data stream may store coordinate information within a screen of an object corresponding to the row 519 illustrated in FIG. 8. Then, a second meta data stream in the playlist 510 in FIG. 6 may store information regarding the number of objects and a bandwidth to be used corresponding to the rows 516 and 517 illustrated in FIG. 7.

Because of this descriptions, the receiving apparatus 102 can selectively acquire coordinate information of a target object. In this case, the relationship between a meta data stream and a video stream to be used for the dynamic template solution can be represented by using dtpl′ as an AType like the example above. In other words, information describing the relationship to be used for the dynamic template solution is information defined with an AType.

On the other hand, the relationship between a meta data stream and a video stream including coordinate information may be represented by using ‘rois’ as an AType as in the playlist 510 in FIG. 6. As a result, the receiving apparatus 102 can grasp the relationship between the video stream and the meta data stream. Though ‘rois’ is used here for indicating the relationship between a meta data stream and a video stream including coordinate information, an embodiment of the present invention is not limited thereto. Other character strings may be used as an AType indicating the coordinate information.

### [Processing in Transmitting Apparatus 101]

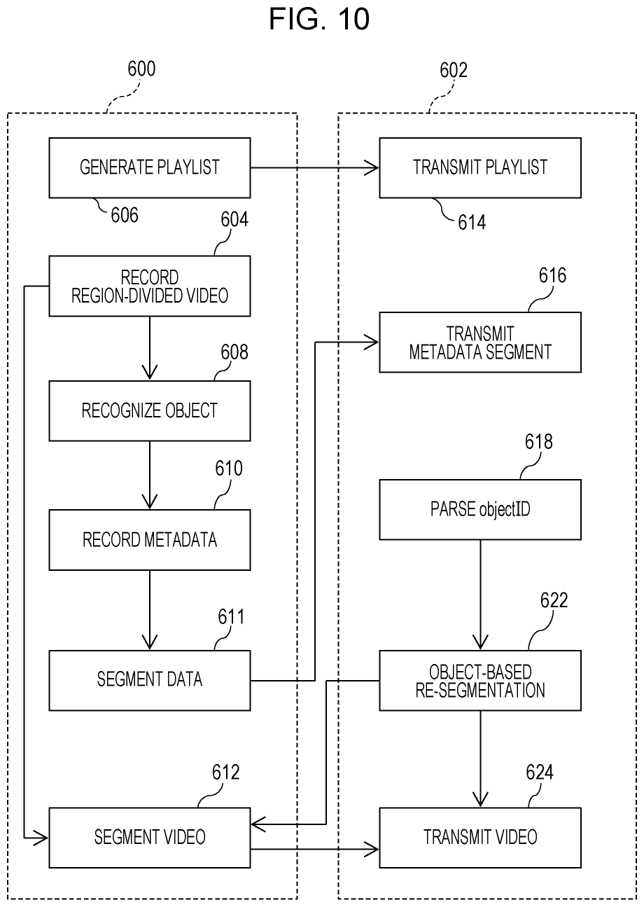

Next, with reference to FIG. 10, processing to be executed by the transmitting apparatus 101 according to this embodiment will be described.

As illustrated in FIG. 10, processing to be executed by the transmitting apparatus 101 may be configured as a two types of task mainly. One type of task is a task 600 for processing a playlist or segment data, and the other type of task is a task 602 for processing a request transmitted from the receiving apparatus 102. The task configuration is an example of the processing configuration of the transmitting apparatus 101 according to this embodiment, but a single type of task or many types of task may be executed.

The task 600 includes processes of RECORD REGION-DIVIDED VIDEO 604, GENERATE PLAYLIST 606, RECOGNIZE OBJECT 608, RECORD META DATA 610, SEGMENT DATA 611, and SEGMENT VIDEO 612.

The video-region dividing unit 202 in FIG. 2 encodes video data acquired by the imaging unit 201 into a region-dividable form and records them to execute RECORD REGION-DIVIDED VIDEO 604. In parallel or substantially simultaneously with the RECORD REGION-DIVIDED VIDEO 604, the playlist generating unit 206 executes the GENERATE PLAYLIST 606. By performing the processing, the task 600 generates the playlists 501, 510, and 520 as illustrated in FIGS. 5, 6, and 9.

Next, the object recognizing unit 203 acquires the number of objects within the video data and their corresponding coordinate information to execute RECOGNIZE OBJECT 608. Furthermore, the video-region identifying unit 204 calculates the band of the video data including the objects from the number of video regions including the objects and records the information in a recording device in the transmitting apparatus 101 to execute RECORD META DATA 610.

The segment generating unit 205 segments the thus recorded meta data (such as 515 and 518) as mp 4 segments to execute SEGMENT DATA 611. According to this embodiment, video data are segmented as mp 4 segments, for example. However, video data may be segmented as MPEG2TSs. Without limiting thereto, segments may be encoded by any encoding method. mp 4 represents a file format provided in MPEG-4, Section 14, that is a moving image compression coding standard.

The segment processing unit 205 executes the SEGMENT VIDEO 612 consecutively in parallel with or subsequently to execution of the processes within the task 600. More specifically, the segment generating unit 205 stores the region-divided video data as separate tracks in different mp 4 segment (or MPEG2TS) to execute SEGMENT VIDEO 612.

On the other hand, the task 602 includes processes of TRANSMIT PLAYLIST 614, TRANSMIT META DATA SEGMENT 616, PARSE objectID 618, OBJECT-BASED RE-SEGMENTATION 622, and TRANSMIT VIDEO 624.

The communicating unit 207 in FIG. 2 monitors a playlist request from the receiving apparatus 102 at all times and, in response to a playlist request, transmits a playlist generated by GENERATE PLAYLIST 606 to the receiving apparatus 102 to execute TRANSMIT PLAYLIST 614. In the same manner, the communicating unit 207 monitors a segment request from the receiving apparatus 102 at all times and, in response to a meta data segment request, transmits a meta data segment recorded by SEGMENT DATA 611 to the receiving apparatus 102. Thus, the communicating unit 207 executes TRANSMIT META DATA SEGMENT 616 included in the task 602.

The communicating unit 207 monitors a segment request from the receiving apparatus 102 at all times. In response to a video segment request, PARSE objectID 618 is requested to analyze which object the requested video segment corresponds.

OBJECT-BASED RE-SEGMENTATION 622 generates a video segment from which a track corresponding to a video region including the requested object is extracted.

The generated video segment (video segment including the ROI) is transmitted to the receiving apparatus 102 through the communicating unit 207. The transmission processing corresponds to TRANSMIT VIDEO 624.

Here, in response to a request for a video segment and a meta data segment for an object requested after the object disappears from a screen, an error is notified to the receiving apparatus 102. Alternatively, a whole video image instead of a video segment may be transmitted.

### [Processing in Receiving Apparatus 102]

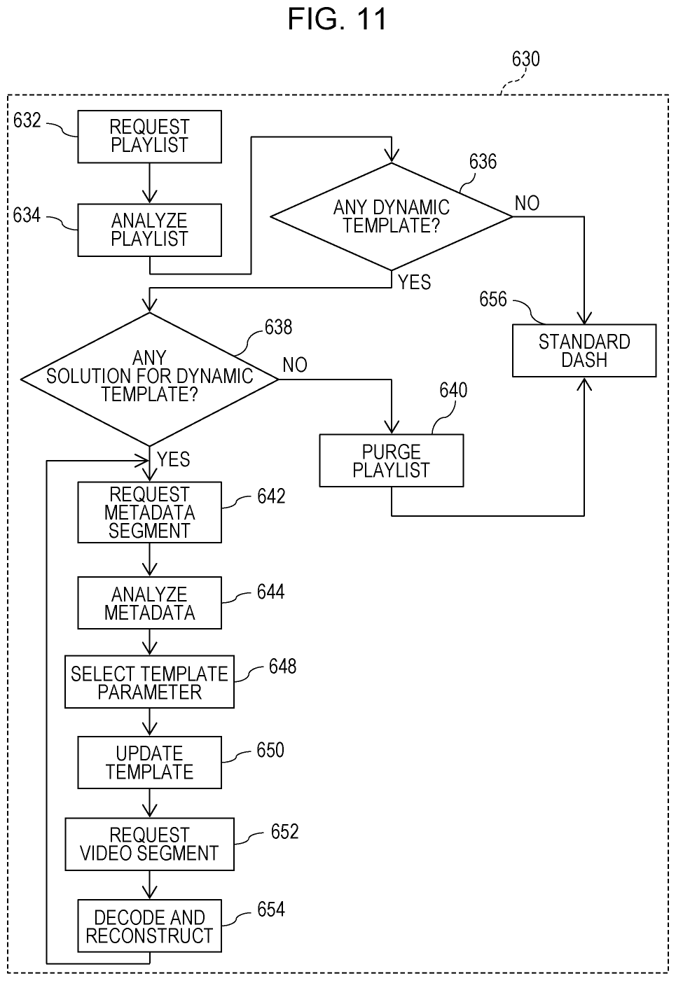

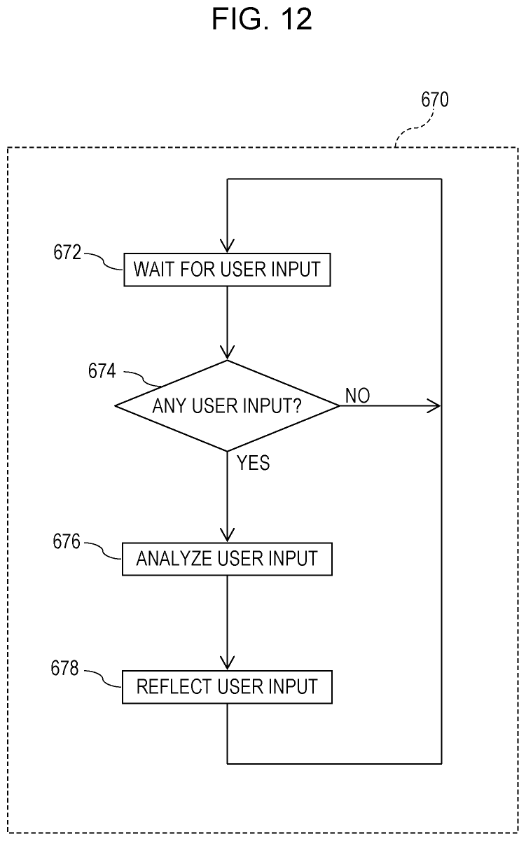

Processing to be performed by the receiving apparatus 102 according to this embodiment will be described with reference to FIGS. 11 and 12. The processing in the receiving apparatus 102 mainly includes two tasks illustrated in FIGS. 11 and 12. One task 630 is a task for processing a playlist and segment data as illustrated in FIG. 11. The other task 670 is a task for processing a request from the user interface unit 307 as illustrated in FIG. 12. The configurations of the tasks are configuration examples of the processing to be performed by the receiving apparatus 102 according to this embodiment and may be implemented by one single task or may be implemented by many types of task.

First of all, the task 630 illustrated in FIG. 11 will be described.

In REQUEST PLAYLIST 632, the communicating unit 306 in the receiving apparatus 102 transmits a playlist request to the transmitting apparatus 101. In ANALYZE PLAYLIST 634, the communicating unit 306 receives a playlist transmitted from the transmitting apparatus 101, and the playlist analyzing unit 304 analyzes the received playlist.

In DETERMINE PRESENCE OF DYNAMIC TEMPLATE 636, the playlist analyzing unit 304 determines whether any dynamic template exists in the received playlist or not. The determination of the presence of a dynamic template can be performed by searching a specific character string in the received playlist. According to this embodiment, as described above, symbols “!” are put around a dynamic template part. By searching the presence of the part, the presence of a dynamic template can be determined. If the determination results in no dynamic template, the processing moves to STANDARD DASH 656 where MPD analysis processing in STANDARD DASH may be performed. If the determination results in presence of a dynamic template, the processing moves to DETERMINE PRESENCE OF SOLUTION FOR DYNAMIC TEMPLATE 638.

In DETERMINE PRESENCE OF SOLUTION FOR DYNAMIC TEMPLATE 638, the playlist analyzing unit 304 determines whether there is any method for solving a dynamic template or not. According to this embodiment, as described above, meta data stream associated on the basis of AType ‘dtpl’ are acquired to solve a dynamic template by using the acquired meta data stream. Here, if there is not associated meta data stream, it is determined that it is impossible to solve a dynamic template. Then, the processing moves to PURGE PLAYLIST 640. If there is associated meta data stream, it is determined that there is a method for solving a dynamic template. The processing then moves to REQUEST META DATA SEGMENT 642. In REQUEST META DATA SEGMENT 642, the communicating unit 306 transmits a request for a meta data segment to the transmitting apparatus 101.

In PURGE PLAYLIST 640, the playlist analyzing unit 304 removes a part associated with a dynamic template from the playlist. After that, the processing moves to STANDARD DASH 656 where processing for performing an MPD analysis in standard DASH is performed.

In ANALYZE META DATA 644, the communicating unit 306 receives a meta data segment and analyzes the received meta data segment.

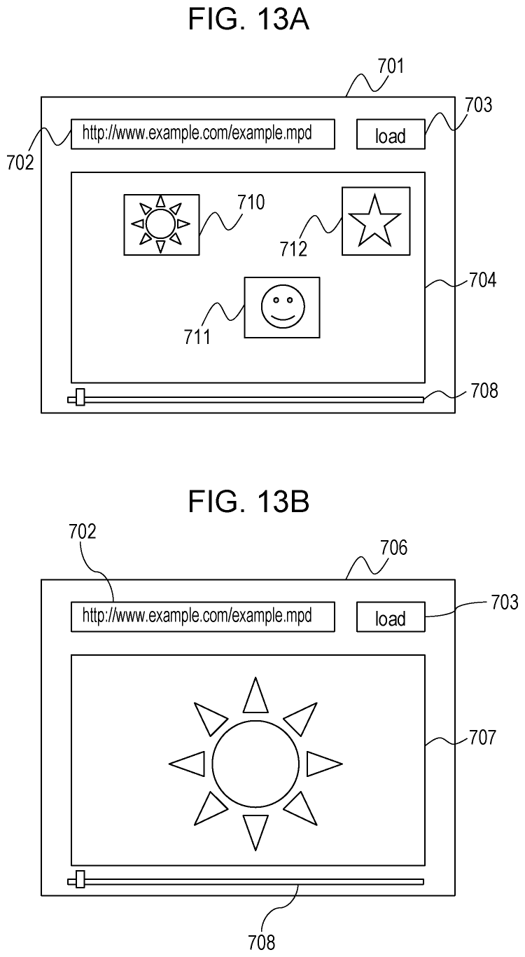

In SELECT TEMPLATE PARAMETER 648, the segment analyzing unit 303 uses information regarding the meta data segment analyzed in ANALYZE META DATA 644 to select a value in the meta data segment to be used as a value (parameter) in a template. A specific method for the selection of a template parameter will be described below with reference to FIGS. 13A and 13B.

In UPDATE TEMPLATE 650, the playlist analyzing unit 304 uses the template parameter selected in SELECT TEMPLATE PARAMETER 648 to update a dynamic template within the playlist. In other words, the segment analyzing unit 303 analyzes the received meta data segment (coordinate segment) and determines which template parameter is to be updated in the playlist. The playlist analyzing unit 304 then updates the playlist on the basis how the playlist is to be updated regarding the meta data segment (coordinate segment) determined by the segment analyzing unit 303.

In REQUEST VIDEO SEGMENT 652, the acquired segment determining unit 305 uses the updated information of the playlist to determine a video segment and requests the determined video segment to the transmitting apparatus 101 as a video segment corresponding to the ROI selected by a user.

In DECODE AND RECONSTRUCT 654, the communicating unit 306 receives the video segment according to the request, and the segment analyzing unit 303 extracts a bit stream from the received video segment. In DECODE AND RECONSTRUCT 654, the decoding unit 302 decodes the extracted bit stream, and the display unit 301 displays the decoded bit stream. In this case, the segment analyzing unit 303 may output the number of objects and the coordinate information, the band information acquired by the meta data analysis processing in ANALYZE META DATA 644 to the display unit 301, and the display unit 301 may display the received information as required.

Next, the processing returns to REQUEST META DATA SEGMENT 642, and the operations in the processing are repeated. The task illustrated in the flowchart in FIG. 11 including the processing is repeated after this until the video streaming ends.

Next, the task 670 illustrated in the flowchart in FIG. 12 will be described.

In WAIT FOR USER INPUT 672, the user interface unit 307 executes processing for waiting a user input. In DETERMINE PRESENCE OF USER INPUT 674, the user interface unit 307 determines whether there is any user input or not. If there is no user input, the processing returns to WAIT FOR USER INPUT 672 where the corresponding operation is performed again. If there is a user input, the processing moves to ANALYZE USER INPUT 676. In ANALYZE USER INPUT 676, the user interface unit 307 analyzes the user input. In REFLECT USER INPUT 678, the user interface unit 307 reflects the analysis result to the internal processing in the receiving apparatus 102.

A specific user input and a reflection example will be described with reference to FIGS. 13A and 13B.

### [Template Parameter Selection Method and User Interface]

A template parameter selection method and a concrete user interface example will be described with reference to FIGS. 13A and 13B. FIGS. 13A and 13B are explanatory diagrams illustrating outer appearances of a touch panel being one concrete example of the user interface unit 307 in the receiving apparatus 102 according to this embodiment. FIGS. 13A and 13B illustrate one concrete example of the user interface unit 307 according to this embodiment. However, the user interface unit 307 is not limited thereto if it has an equivalent functionality thereto.

FIG. 13A illustrates one display screen 701 on the user interface unit 307 before an object selection. FIG. 13B illustrates a display screen 706 on the user interface unit 307 after an object is selected. FIGS. 13A and 13B illustrate an input box area 702 in which a URL for a playlist can be input and a load button 703 to be pressed for issuing a request to acquire a playlist to the URL input in the input box area 702.

In DETERMINE PRESENCE OF USER INPUT 674, if the user interface unit 307 detects a press on the load button 703, the user interface unit 307 in ANALYZE USER INPUT 676 analyzes the user input. In REFLECT USER INPUT 678, the user interface unit 307 reflects the result of the analysis and that a request for a playlist has been input to the internal processing in the receiving apparatus 102. As a result, REQUEST PLAYLIST 632 in the task illustrated in FIG. 11 is started.

In a case where a user inputs a URL in the input box area 702, the user interface unit 307 displays a (candidate) list of URLs and may prompt to select a target URL from the displayed (candidate) list. In order to fix a URL, a URL set (fixed) by a user in advance may be displayed in a fixed manner in the input box area 702. In order to request to acquire a predetermined URL only, the user interface unit 307 may not display the input box area 702.

FIG. 13A illustrates a frame 704 for displaying a video image, and FIG. 13B illustrates a frame 707 for displaying a video image. FIGS. 13A and 13B illustrate a slide bar 708 usable for setting a time corresponding to a video image to requested to view by a user. A user may operate the slide bar 708 to select which part of a whole stream to be viewed.

If the user interface unit 307 detects a operation on the slide bar 708 in ANALYZE USER INPUT 676, the user interface unit 307 in REFLECT USER INPUT 678 transmits the operation to the acquired segment determining unit 305. As a result, in REQUEST VIDEO SEGMENT 652, the acquired segment determining unit 305 updates the time of a requested video segment to reflect information regarding the time corresponding to a video image requested to view by the user.

Having described that, in SELECT TEMPLATE PARAMETER 648, the segment analyzing unit 303 selects a value (parameter) for a template to be used, a parameter may be selected to represent a whole video image instead. In the beginning of playback of video, a whole video image is displayed without limiting an area such that a user can easily select an object within a user screen. In this case, for example, in the first SELECT TEMPLATE PARAMETER 648, the segment analyzing unit 303 can select information designated with ObjectID=0 in the meta data 515.

In a case where a stream of a whole video image is described as another AdaptationSet without using a dynamic template, the other AdaptationSet may simply be acquired initially. In the processing in the receiving apparatus 102 at that time, the segment analyzing unit 303 may extract coordinate information of an object such as the row 519 in the meta data 518 as described above and supplies the extracted coordinate information to the display unit 301. Because of this processing, the user interface unit 307 may cause the display unit 301 to display the coordinate information of the object as frames 710, 711, and 712.

As illustrated in the display example 701 in FIG. 13A, the display unit 301 may display video data and meta data having identical time information over the video image. With such a display configuration, the display unit 301 can present to a user both of a whole video image and the coordinate information of objects included in the whole video image.

After a video image showing the display example 701 presented by the display unit 301 to a user, the user may select an object to be focused on the user interface unit 307. Thus, as illustrated in the display example 706, a video image only showing an object to be focused may be displayed.

In a case where an object shown in the frame 710 is selected as an object to be focused by a user in FIG. 13A, for example, a video image including the selected object is displayed as illustrated in FIG. 13B, for example.

According to a method for selecting an object by a user, the user interface unit 307 may detect a touch input or a mouse input operated by a user, for example, and determine that a press is given within the frame 710. As a result of such a determination, the user interface unit 307 may determine that an object with an ObjectID corresponding to the frame (710, for example) is selected. According to this embodiment, a touch input or a mouse input given by a user is a concrete user input example. However, without limiting thereto, an input may be given by using a keyboard, or an audio input may be given.

If the user interface unit 307 in ANALYZE USER INPUT 676 detects a selection of an object, the user interface unit 307 in REFLECT USER INPUT 678 executes processing for reflecting information regarding the selected object. In accordance with the reflection, the segment analyzing unit 303 in SELECT TEMPLATE PARAMETER 648 determines a parameter to be selected. For example, in a case where a press through a user input is performed within the frame 710, the user interface unit 307 acquires the relative coordinate information of the frame 710 within the frame 704. The user interface unit 307 then transmits the acquired coordinate information to the acquired object determining unit 308.

The acquired object determining unit 308 can deduce the ObjectID corresponding to the object selected on the screen from the correspondence relationship between the relative coordinate information and the ObjectID and its corresponding coordinates acquired from the meta data analyzed by the segment analyzing unit 303. The acquired object determining unit 308 supplies the information regarding the deduced ObjectID to the acquired segment determining unit 305. Through the processing, like the processing in the receiving apparatus 102, the acquired segment determining unit 305 can update the dynamic template and determine a video segment to be acquired. A screen after the object selection may display the selected object only as in the display example 706. In this case, the video data to be acquired may be a combination of four divided regions like the divided regions 403. All of the divided regions 403 may be displayed, or a cut-out region 409 as a result of cropping by using coordinate information of an object may be displayed.

There may be a case where a whole video image of the display example 701 is to be displayed in order to return from a screen display state after an object selection operation to a state that another object is selectable. In this case, a user may press an arbitrary point within the frame 707 by performing a user input, or a separate button usable for returning to the whole video image may be provided to prompt a user to press it. In order for a user to return to the display of the whole video image, ObjectID=0 may be selected in SELECT TEMPLATE PARAMETER 648 to return to the initial state.

### Variation Example

As a variation example, in order to prompt a user to select an object to be focused initially, the receiving apparatus 102 before video is displayed within the frame 704 may display the initial frame within the video segment intended to be viewed by a user as a still image. The display may be executed by the display unit 301 in the receiving apparatus 102. In this case, the communicating unit 306 may only acquire from the transmitting apparatus 101 a video segment including the initial frame intended to be viewed by a user as a video segment to be acquired. The communicating unit 306 may only acquire from the transmitting apparatus 101 a meta data segment corresponding to the time of the initial frame intended to be viewed by a user. In the same manner as the method according to this embodiment, a video image including an object selected may be requested to the transmitting apparatus 101 when a user is prompted to perform the selection.

### [Sequence Diagram]

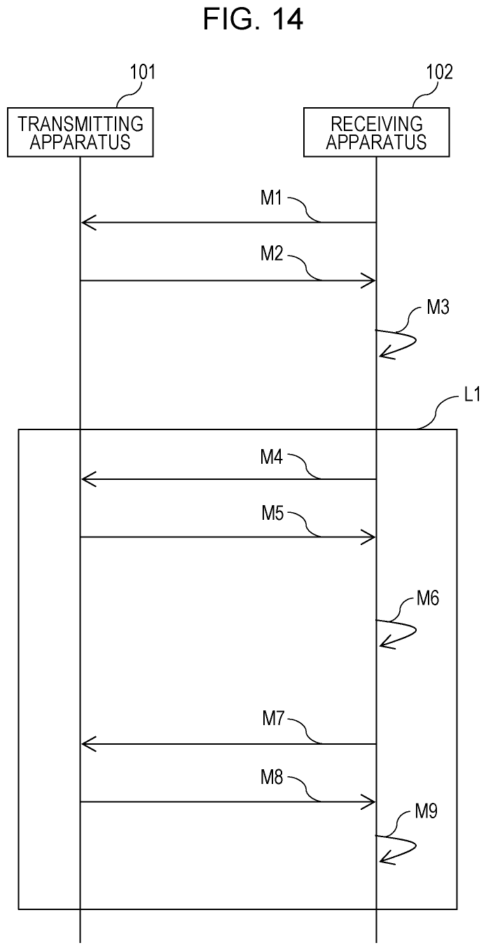

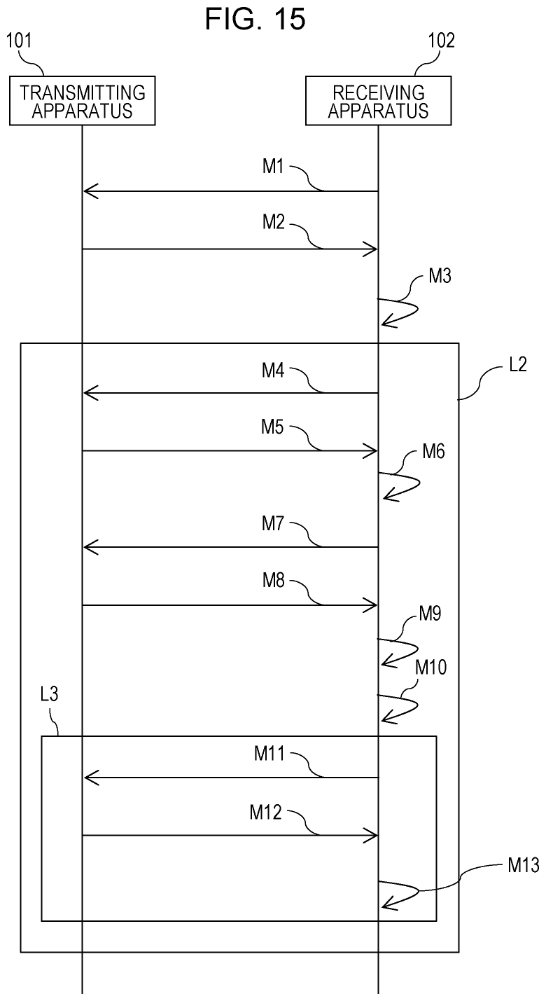

With reference to sequence diagrams illustrated in FIGS. 14 and 15, a concrete example of transmission and reception to be performed between the transmitting apparatus 101 and the receiving apparatus 102 according to this embodiment will be described.

In ANALYZE USER INPUT 676 in FIG. 12, the user interface unit 307 detects a user input for requesting for a playlist. Then in REFLECT USER INPUT 678, the user interface unit 307 reflects the input request to the processing in the receiving apparatus 102, and the sequence as illustrated in FIG. 14 starts.

In M1, the receiving apparatus 102 transmits a playlist request to the transmitting apparatus 101. This processing corresponding to the processing in REQUEST PLAYLIST 632. In M2, the transmitting apparatus 101 transmits the playlist generated in GENERATE PLAYLIST 606 to the receiving apparatus 102 as a playlist response being a response to the playlist request. Here, in a case where GENERATE PLAYLIST 606 is not completed within the transmitting apparatus 101 and it is not ready for transmission of a playlist, the communicating unit 207 in the transmitting apparatus 101 in M2 may return an error.

In M3, the receiving apparatus 102 performs a playlist analysis by using the received playlist. This corresponds to the processing in ANALYZE PLAYLIST 634, DETERMINE PRESENCE OF DYNAMIC TEMPLATE 636, DETERMINE PRESENCE OF SOLUTION FOR DYNAMIC TEMPLATE 638, and PURGE PLAYLIST 640. In M4, the receiving apparatus 102 transmits a meta data segment request corresponding to the time corresponding to an image intended to be viewed by a user to the transmitting apparatus 101 in accordance with the result of the playlist analysis in M3. This corresponds to the processing in REQUEST META DATA SEGMENT 642.

In M5, the transmitting apparatus 101 transmits a meta data segment generated in SEGMENT DATA 611 as a meta data segment response. In M5, in a case where SEGMENT DATA 611 is not completed within the transmitting apparatus 101 and it is not ready for transmission of the meta data segment, the communicating unit 207 in the transmitting apparatus 101 may return an error.

In M6, the receiving apparatus 102 may perform a meta data analysis and a template update by using the received meta data segment. This corresponds to the processing in ANALYZE META DATA 644, SELECT TEMPLATE PARAMETER 648, and UPDATE TEMPLATE 650. In M7, the receiving apparatus 102 transmits a video segment request (video segment distribution request) corresponding to an object and a time intended to be viewed by a user to the transmitting apparatus 101 in accordance with the results of the meta data analysis and the template update. This corresponds to the processing in REQUEST VIDEO SEGMENT 652.

In M8, the transmitting apparatus 101 transmits a video segment generated in SEGMENT VIDEO 612 to the receiving apparatus 102 as a video segment response. Here, in a case where SEGMENT VIDEO 612 is not completed within the transmitting apparatus 101 and it is not ready for transmission of a video segment, the communicating unit 207 in the transmitting apparatus 101 in M8 may return an error. In M9, the receiving apparatus 102 decodes and reconstructs a video image by using the received video segment. This corresponds to the processing in DECODE AND RECONSTRUCT 654.

In L1, the processing from M4 to M9 is repeated.

FIG. 15 is a sequence diagram illustrating operations of the user interface unit 307 according to a template parameter selection method and according to this embodiment. Because the processing from M1 to M8 in FIG. 15 is the same as the processing from M1 to M8 in FIG. 14, any repetitive description will be omitted. The decoding and reconstructing processing in M9 in FIG. 15 is different from the processing in M9 in FIG. 14 in that decoding for one frame is performed to display the resulting still image.

In M10, a user in the receiving apparatus 102 selects an object. In M11, the receiving apparatus 102 transmits a video segment request to the transmitting apparatus 101 in accordance with the object selected by the user. The processing corresponds to the processing in SELECT TEMPLATE PARAMETER 648, UPDATE TEMPLATE 650, and REQUEST VIDEO SEGMENT 652. Because the processing in M12 and M13 is the same as the processing in M8 and M9, respectively, in FIG. 12, any repetitive description will be omitted.

The processing from M11 to M13 is repeated in loop processing L3 until a request to change the selected object or a viewing time is received. In response to a request to change the selected object or a viewing time T, the loop processing L3 ends, and the processing returns to loop processing L2. In other words, the processing is started from M4 again and is repeated in the loop processing L3.

According to this embodiment, a request to change the selected object or a viewing time may occur in response to a user input received by the user interface unit 307 as described above. Alternatively, the request may occur in response to error information transmitted from the transmitting apparatus 101 when an object of interest disappears from a screen or may be triggered by reception of a whole video image.

### Hardware Configuration Example

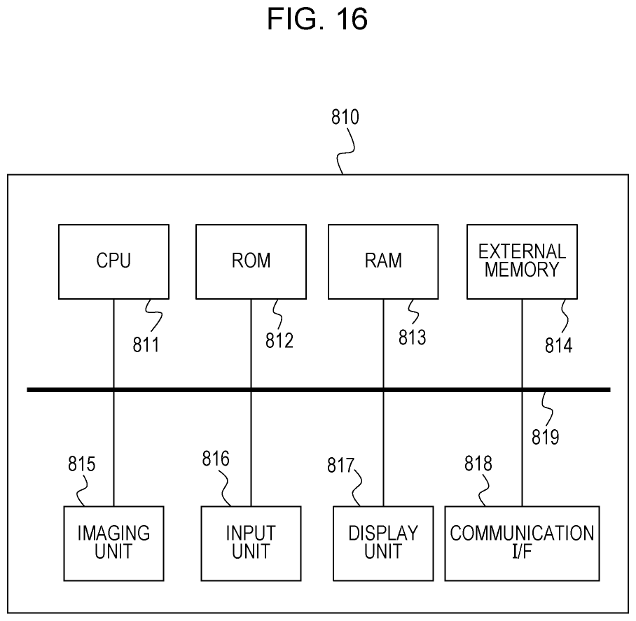

FIG. 16 illustrates a configuration example of a computer 810 including the units of the aforementioned embodiments. For example, the transmitting apparatus 101 illustrated in FIG. 2 may be configured by the computer 810. The components of the receiving apparatus 102 illustrated in FIG. 3 may be configured by the computer 810.

A CPU 811 may execute programs stored in a ROM 812, a RAM 813, and an external memory 814, for example, to implement the components of the aforementioned embodiments. The ROM 812 and the RAM 813 are capable of holding programs to be executed by the CPU and data. The RAM 813 may hold the playlist 501 and the meta data 515, for example.

The external memory 814 may be configured by a hard disk, an optical disk, or a semiconductor storage device, for example, and may store video segments, for example. An imaging unit 815 may configure the imaging unit 201.

An input unit 816 may configure the user interface unit 307. The input unit 816 may be configured by a keyboard and a touch panel or may be configured by a pointing device such as a mouse and switches.

A display unit 817 may configure the display unit 301 in FIG. 3 but may be configured by any other display device. A communication I/F 818 may be an interface for external communication and may configure the communicating unit 207 in FIG. 2 and the communicating unit 306 in FIG. 3. These components of the computer 810 are connected to each other via a bus 819.

With the configuration of the aforementioned embodiments, the processing relating to distribution of a region of interest to be distributed in video data can be executed efficiently.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication apparatus comprising:
an identifying unit configured to identify an object region having an object within a video image;
a generating unit configured to generate a meta data segment including an identifier or identifiers of one or more objects corresponding to one or more object regions identified by the identifying unit;
a transmitting unit configured to transmit the meta data segment generated by the generating unit to another communication apparatus; and
a supplying unit configured to supply, to said another communication apparatus which received the meta data segment, a video segment including an object region corresponding to an object selected in said another communication apparatus.

2. The communication apparatus according to claim 1, wherein the meta data segment includes first identification information used by said another communication apparatus for requesting a video segment of a first object region having a first object detected from the video image and second identification information used by said another communication apparatus for requesting a video segment of a second object region having a second object.

3. The communication apparatus according to claim 2, wherein the meta data segment includes the first identification information used by said another communication apparatus for requesting video data of the first object region of first quality and third identification information used by said another communication apparatus for requesting a video segment of the first object region of second quality.

4. The communication apparatus according to claim 1, further comprising:
a dividing unit configured to divide the video image into a plurality of divided regions,
wherein the identifying unit identifies the object region by handling each one of the divided regions as a result of the division performed by the dividing unit as one unit.

5. The communication apparatus according to claim 2, wherein the meta data segment includes first position information regarding a position within the video image of the first object and second position information regarding a position within the video image of the second object.

6. The communication apparatus according to claim 2, wherein the meta data segment includes first size information regarding a size of the first object within the video image and second size information regarding a size of the second object within the video image.

7. The communication apparatus according to claim 1, wherein the transmitting unit further transmits, to said another communication apparatus, a playlist including a resource identifier used by said another communication apparatus for requesting the meta data segment; and
the transmitting unit transmits the meta data segment to said another communication apparatus in response to receiving the request according to the resource identifier described in the playlist.

8. The communication apparatus according to claim 7, wherein the generating unit generates the meta data segment and the playlist such that a video segment of an object region corresponding to an object selected in said another communication apparatus can be requested by using a combination of a resource identifier described in the playlist and identification information based on the identifier of the object.

9. The communication apparatus according to claim 1, wherein the meta data segment includes identification information usable by the other communication apparatus for requesting full video of the video image.

10. The communication apparatus according to claim 9, wherein the resource identifier is a Uniform Resource Locator (URL).

11. A communication apparatus comprising:
a receiving unit configured to receive a meta data segment including an identifier or identifiers of one or more objects within a video image;
a display control unit configured to cause a display device to display information regarding the one or more objects on the basis of a meta data segment received by the receiving unit;
a selecting unit configured to select an object from the one or more objects whose identifier is described in the meta data segment in response to receipt of an instruction to the display device; and
a requesting unit configured to request a video segment corresponding to a partial region having one or more objects selected by the selecting unit.

12. The communication apparatus according to claim 11, wherein the receiving unit further receives the video image; and
the display control unit causes the display image to display the video image and information describing a position or positions of the one or more objects within the video image.

13. The communication apparatus according to claim 11, wherein the receiving unit receives a playlist describing relationship between the video segment and the meta data segment by using a resource identifier; and
the requesting unit requests a video segment corresponding to a partial region having the selected object or objects on the basis of a resource identifier described in the playlist.

14. A control method for a communication apparatus, the method comprising:
identifying an object region having an object within a video image;
generate a meta data segment including an identifier or identifiers of one or more objects corresponding to one or more object regions identified by the identifying;
transmitting the meta data segment generated by the generating to another communication apparatus; and
supplying, to said another communication apparatus which received the meta data segment, a video segment including an object region corresponding to an object selected in said another communication apparatus.

15. A non-transitory computer-readable media storing a program for causing a computer to execute a method comprising:
identifying an object region having an object within a video image;
generate a meta data segment including an identifier or identifiers of one or more objects corresponding to one or more object regions identified by the identifying;
transmitting the meta data segment generated to a communication apparatus; and
supplying, to the communication apparatus which received the meta data segment, a video segment including an object region corresponding to an object selected in said another communication apparatus.

16. A control method for a communication apparatus, the method comprising:
receiving a meta data segment including an identifier or identifiers of one or more objects within a video image;
causing a display device to display information regarding the one or more objects on the basis of a meta data segment received by the receiving;
selecting an object from the one or more objects whose identifier is described in the meta data segment in response to receipt of an instruction to the display device; and
requesting a video segment corresponding to a partial region having one or more objects selected.

17. A non-transitory computer-readable media storing a program for causing a computer to execute a method comprising:
receiving a meta data segment including an identifier or identifiers of one or more objects within a video image;
causing a display device to display information regarding the one or more objects on the basis of a meta data segment received by the receiving;
selecting an object from the one or more objects whose identifier is described in the meta data segment in response to receipt of an instruction to the display device; and
requesting a video segment corresponding to a partial region having one or more objects selected by the selecting.
